(19) United States
(12) Patent Application Publication
(10) Pub. No.: US 2011/0293437 A1
(43) Pub. Date: Dec. 1, 2011

(54) WIND TURBINE BLADE WITH A CONDUCTIVELY DOPED COATING FOR LIGHTNING PROTECTION OF THE WIND TURBINE BLADE AND METHOD FOR MANUFACTURING THE WIND TURBINE BLADE

(76) Inventors: Florian Krug, Munchen (DE); Bastian Lewke, Herning (DK)

(21) Appl. No.: 13/109,248

(22) Filed: May 17, 2011

(30) Foreign Application Priority Data
May 27, 2010 (EP) 10164062.1

(51) Int. Cl. F01D 5/14; B05D 1/24

(52) U.S. Cl. 416/241 A; 427/201

(57) ABSTRACT

A wind turbine blade is provided having a base body with a base material and at least one coating of the base body with a coating material, wherein the coating material includes a composite material with conductive particles. The composite material includes fiber glass. In one embodiment, the fiber glass forms a glass fiber mat. Additionally a method for manufacturing such a wind turbine blade is provided. The method includes: a) providing the base body of the wind turbine blade; and b) applying the coating on a surface of the base body.

### BACKGROUND OF THE INVENTION

1. Field of the Invention

This invention relates to a wind turbine blade with a conductively doped coating for lightning protection of the wind turbine blade. Moreover a method for manufacturing the wind turbine blade is presented.

2. Description of the Related Art

A blade material of a wind turbine blade, e.g. GFRP (glass fiber reinforced polymer), can be destroyed by a lightning stroke (e.g. composed by a leader and a return stroke). Therefore a wind turbine blade usually has a lightning protection system.

The lightning protection system consists of lightning receptors at a blade surface of the blade. Inside the blade there are conductors with conductive material connected to the receptors. Via the conductors lightning current which is caused by a direct lightning stroke into the receptors can be diverted.

An area of the receptors is limited leading to a relatively small safe contact surface for the lightning stroke (few square centimeters) compared to the whole blade surface (e.g. 100 square meters). Due to that fact a probability for a direct lightning stroke into the lightning receptors is relatively low. As a consequence a puncture of the blade material caused by a lightning stroke into the blade surface cannot be avoided.

DE 10 2006 044 323 A1 discloses a wind turbine blade with a special lightning protection system. Thereby the wind turbine blade has a base body with a base material and a coating of the base body with a coating material. The coating material comprises a composite material. A main material of the composite material is a ceramic material. In this ceramic material conductive particles are distributed. The conductive particles comprise iron.

While rotating the wind turbine blade vibrations of the wind turbine blade occur. Due to the brittleness of the ceramic material a probability of mechanical spalling of the coating known from DE 10 2006 044 323 A1 is relatively high. The reliability of the lightning protection system is reduced.

### SUMMARY OF THE INVENTION

It is an object of the invention to provide a wind turbine blade with an efficient and more reliable lightning protection system compared to the known state of the art.

Another object of the invention is the providing of a method for manufacturing such a wind turbine blade.

These objects are achieved by the invention specified in the claims.

### BRIEF DESCRIPTION OF THE INVENTION

The invention provides a wind turbine blade having a base body with a base material and at least one coating of the base body with a coating material, wherein the coating material comprises a composite material with conductive particles. The wind turbine blade is characterized in that the composite material comprises fiber glass. Preferably the fiber glass form a glass fiber mat. A glass fiber mat is used. The coating of the wind turbine blade is conductively doped. Preferably the conductive particles comprise a highly conductive metal like copper or silver. Other metals like iron, antimony or an alloy consisting different metals are possible, too. An average diameter of the particles ranges from nanometer to millimeter. Preferably the diameter of the particles is selected from the range between 10 μm to 500 μm.

Additionally the invention provides a method for manufacturing such a wind turbine blade. The method comprises following steps: a) Providing the base body of the wind turbine blade; and b) Applying the coating on a surface of the base body. In a preferred embodiment the applying of the coating comprises an applying of the fiber glass on the surface of the base body. After that a main material (or a precursor material of the main material) of the composite material will be applied. A simultaneously applying of glass fiber and main material of the composite material is possible, too. Moreover in a first step the main material can be applied on the surface of the base body. After that the fiber glass can be applied.

In a preferred embodiment a particle percentage of the conductive particles in the composite is selected from the range from 20 wt % (weight percent) to 50 wt % and in particular from 25 wt % to 40 wt % of the composite. In particular, a higher particle percentage is possible, too. In a further preferred embodiment the coating has a coating thickness selected from the range from 50 μm to 500 μm. For instance the coating thickness is 100 μm. This results in a flexible coating with a high ampacity.

By using fiber glass the coating of the base body of the wind turbine blade is more flexible than the coating of the above described state of the art. The probability of mechanical spalling due to vibrations of the wind turbine blade is reduced. Concurrently based of the conductive particles the coating can act as an efficient protective coating for lightning strokes. A resistance of the base material of the base body of the wind turbine blade, e.g. a polymer material, is much higher than a resistance of the coating material. By that lightning current can be guided via the coating. The lightning current is not guided through the base body of the wind turbine blade. Therefore the probability of a puncture of a wind turbine blade with such a coating is reduced in comparison to the probability of a puncture of a wind turbine blade without such a coating.

In view of a low resistance of the coating it is preferred that at least a part of the conductive particles is in contact with each other. This results in highly conductive junctions between the conductive particles.

In a preferred embodiment the fiber glass comprise an epoxy coating. The fiber glass are coated by an epoxy. A surface of the fiber glass are covered by an epoxy. For instance the fiber glass are impregnated with an epoxy casting resin before or after the applying the fiber glass on the surface of the base body. The epoxy coating of the fiber glass leads to a higher flexibility of the coating of the base body in comparison to a coating of the base body with fiber glass without an epoxy coating. Moreover the bonding between the fiber glass and the surface of the base body and therefore the bonding between the coating and the surface of the base body is improved by the epoxy coating of the fiber glass. This leads to robust assembly.

In a further preferred embodiment the epoxy coating comprises the conductive particles. Fiber glass with an epoxy coating having the conductive particles are used. By that the conductive particles can be selectively distributed in the composite. For instance after applying the epoxy resin on the glass fiber mat conductive particles are deposited on the non cured resin. The conductive particles are arranged along s structure which is given by the fiber glass and the glass fiber mat respectively.

In view of a further enhancement of the robustness of the wind turbine blade it is preferred that the composite material comprises the base material of the base body. This reduces a thermal mismatch between the base material and the composite material. The structural stability of the assembly is improved.

In a preferred embodiment the base material comprises GFRP. The base material of the wind turbine blade comprises fiber glass. Since fiber glass are also used for the coating of the base body of the wind turbine blade a very stable assembly results.

In a preferred embodiment the coating of the base body of the wind turbine blade is electrically connected to a lightning receptor. Thereby the coating of the base body of the wind turbine blade and the lightning receptor can be directly arranged to each other. Alternatively at least one diverter is arranged between the coating and the lightning receptor. The diverter guides the lightning current from the coating to the lightning receptor. Moreover the diverter can be carried out by the coating.

### BRIEF DESCRIPTION OF THE DRAWING

Further features and advantages of the invention are disclosed by the description of exemplary embodiments with reference to the schematic drawings.

FIG. 1 shows a detail of a side cut of a first embodiment of a wind turbine blade with a conductively doped coating.

FIG. 2 shows a detail of a side cut of a second embodiment of a wind turbine blade with a conductively doped coating.

FIG. 3 shows a detail of the first and a detail of the second embodiment respectively from the top.

### DETAILED DESCRIPTION OF THE INVENTION

Given is a wind turbine blade 1. The wind turbine blade 1 has a base body 11. The base material of the base body comprises GFRP.

On a surface 111 of the base body a coating 12 is arranged. The coating material of the coating comprises a composite material. The composite material comprises a (not shown) glass fiber mat and conductive particles 13. The fiber glass are coated by an epoxy. The particle material of the conductive particles is silver. The average diameter of the particles is about 100 μm. The blade material of the wind turbine blade is GFRP.

The wind turbine blade 1 has a lightning protection system. This lightning protection system comprises a lighting receptor 2 which is integrated into the wind turbine blade 1. A receptor surface 211 of the lightning receptor 2 and a blade surface 101 of the wind turbine blade 1 which is formed by the coating 12 are flushed with each other.

The lightning receptor 2 is made out of one piece comprising a metal as receptor material. The lightning receptor 2 is connected to inner conductors 21 comprising conductive material of the blade 1.

The lightning receptor and the coating are electrically connected with each other. For a well-directed flow of a lightning current caused by a lightning stroke between the coating and the lightning receptor diverters 3 are arranged.

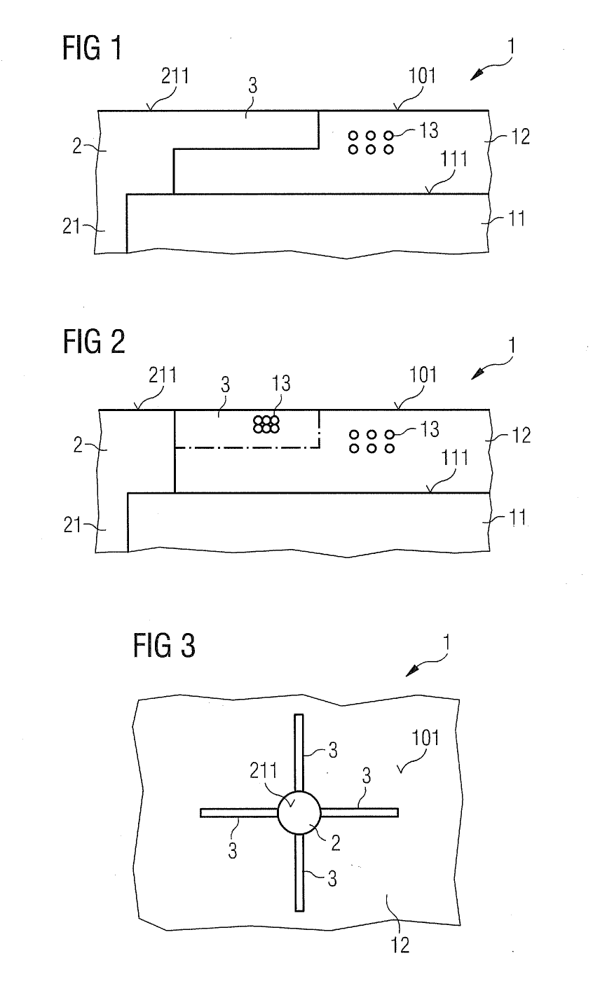

In the first embodiment (FIG. 1) bulk metal is arranged between the coating and the lightning receptor forming a diverter. In the second embodiment (FIG. 2) the diverters are formed by the conducting particles of the composite material. A higher conductivity of the diverters is reached by a compacting of the conductive particles.

In the case a lightning strikes the coating the resulting lightning current is guided via the diverters to the lightning receptor. Due to the higher resistance of the body material of the base bode of the wind turbine blade compared to the coating material of the coating no breakthrough through the base body occurs. As a result the probability of a damage of the wind turbine blade is reduced.

For manufacturing the wind turbine blade following steps are carried out: a) Providing the base body of the wind turbine blade and b) applying the coating on a surface of the base body.

The applying the coating comprises an applying of a glass fiber mat on the surface of the base body. The glass fiber mat and the base body of the wind turbine blade are brought together. The fiber glass of the used glass fiber mat are coated with an epoxy. Therefore the glass fiber mat is impregnated with an epoxy casting resin. The epoxy coating of the glass fiber comprise the conductive particles. Therefore after impregnating the glass fiber with the epoxy resin conductive particles are deposited on the impregnated glass fiber.

1.-14. (canceled)

15. A wind turbine blade, comprising:
a base body with a base material; and
a coating of the base body with a coating material, the coating material comprising:
a composite material comprising:
conductive particles, and
fiber glass.

16. The turbine blade according to claim 15, wherein the fiber glass forms a glass fiber mat.

17. The turbine blade according to claim 15, wherein a particle percentage of the conductive particles in the composite material is selected from the range from 20 wt % to 50 wt %.

18. The turbine blade according to claim 17, wherein the particle percentage of the conductive particles in the composite material is selected from the range from 25 wt % to 40 wt %.

19. The turbine blade according to claim 15, wherein the coating has a coating thickness selected from the range from 50 μm to 500 μm.

20. The turbine blade according to claim 15, wherein at least a part of the conductive particles is in contact with each other.

21. The turbine blade according to claim 15, wherein the fiber glass is coated with an epoxy coating.

22. The turbine blade according to claim 21, wherein the epoxy coating comprises the conductive particles.

23. The turbine blade according to claim 15, wherein the composite material comprises the base material of the base body.

24. The turbine blade according to claim 15, wherein the base material comprises glass fiber reinforced polymer.

25. The turbine blade according to claim 15, wherein the coating is electrically connected to a lightning receptor.

26. A method for manufacturing a wind turbine blade comprising:
providing a base body of the wind turbine blade, the base body with a base material; and
applying a coating on a surface of the base body, the coating material comprising:
a composite material comprising:
conductive particles, and
fiber glass.

27. The method according to claim 26, wherein the applying the coating comprises an applying of fiber glass on the surface of the base body.

28. The method according to claim 26, wherein fiber glass is coated by an epoxy coating.

29. The method according to claim 28, wherein fiber glass with an epoxy coating having the conductive particles are used.
